(19) United States
(12) Patent Application Publication
(10) Pub. No.: US 2010/0294702 A1
(43) Pub. Date: Nov. 25, 2010

(54) Physically and chemically emulsified hydrocarbon waters separator for ship's bilges

(75) Inventors: Camilo Vázquez Pérez, Arteixo (A Coruna) (ES); José Saavedra Pereira, Arteixo (A Coruna) (ES)

Correspondence Address: KLAUBER & JACKSON, 411 HACKENSACK AVENUE, HACKENSACK, NJ, 07601, US

(73) Assignee: FACET IBERICA S.A.

(21) Appl. No.: 12/804,784

(22) Filed: Jul. 29, 2010

Related U.S. Application Data
(63) Continuation of application No. 11/141,982, filed on Jun. 1, 2005, now abandoned.
Application No. 11/141,982 is a continuation of application No. 10/351,233, filed on Jan. 24, 2003, now abandoned.

(30) Foreign Application Priority Data
Jan. 25, 2002 (ES) P200200951

(51) Int. Cl. C02F 1/00; B01D 35/14; C02F 101/32

(52) U.S. Cl. 210/86

(57) ABSTRACT

A separator for use in ships' bilges capable of physical and chemical separation of both free and emulsified hydrocarbons from a water stream that includes two separation units, the first one being a gravimetric separation unit that utilizes coalescent plates to separate free hydrocarbon in the mixture of water/hydrocarbons and a pump which recirculates the water emulsified hydrocarbon mixture through the self-filtration unit and also sends the separated hydrocarbons in the gravimetric unit to the corresponding deposit of free hydrocarbons collecting tank, and the second separation unit being a membrane ultrafiltration apparatus to separate the emulsified hydrocarbons from the water stream, the separator also including a control panel that controls the operation of all elements and devices of the separator, and a phase detector which determines the quantity of accumulated hydrocarbons at the top part of the gravimetric unit.

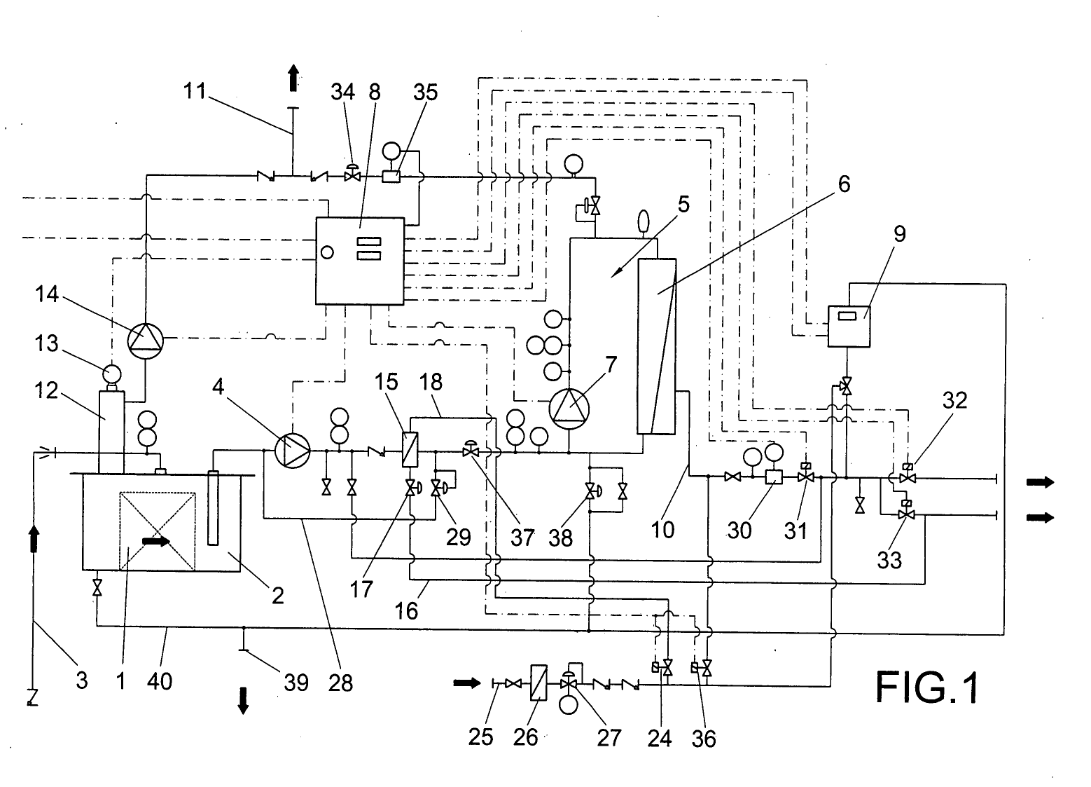

The present application is a continuation of U.S. patent application Ser. No. 11/141,982, filed Jun. 1, 2005 and which is, in turn, a continuation application of U.S. Serial number No. 10/351,233 which was filed on Mar. 24, 2003 and the content of both of those patent applications are incorporated into the present application in their entirety by reference.

### OBJECT OF THE INVENTION

The present invention, as it is expressed in the present specification, refers to a physically and chemically emulsified hydrocarbon/water separator, constructed to separate in water emulsified hydrocarbons, allowing the separation of the free hydrocarbon and the emulsified hydrocarbons from a water stream. It is based on the combination of two separation techniques: on the one hand, the gravimetric separation through coalescent plates and, on the other hand, the separation through ultrafiltration membranes, which are self cleanable through counter-flow.

The separator is automatic, it operates electrically and is self supported in its own sole plate. It is applicable to most industries in all cases and practical circumstances in which it is necessary to separate hydrocarbons-water or mineral oils and water mixtures, although its foreseen preferential application is in ship bilges.

### BACKGROUND OF THE INVENTION

When it becomes necessary to make a separation of emulsions in a water-hydrocarbons mixture, the most generalised separation process is based on pH modification in order to break emulsions through the insertion of acid and/or basic components. This makes it possible to separate hydrocarbons from water.

The problem arising from this process is the measurement of the reagents, since the quantity of each one of these reagents will depends on the components and pH of the mixture to be separated, requiring expensive regulation and maintenance systems.

### DESCRIPTION OF THE INVENTION

The purpose of the emulsions separator of the invention is based on the combination of two technologies, one is the gravimetric separation of hydrocarbons from water, and the other one is the ultrafiltration in membranes. This way, in a first stage, the separation process by gravity through the use of a coalescent plate separator allows the elimination of all water-free hydrocarbon, reaching concentrations below 15 ppm. In the second stage the separation of the emulsified hydrocarbon is obtained in the membranes; all done with no need of breaking the emulsion by means of pH modification and the necessity of using reagents.

Basically, the separator comprises a gravimetric separation unit of hydrocarbon-water, with the FACET MPACK COALESCENT PLATES PACK (these are coalescent plates provided with integral moldings that ensure the spacings are accurately controlled while at the same time promoting the transfer of solids to the bottom of the installation). This unit receives the hydrocarbon-water mixture to be treated, by positioning a pump that separates the water free hydrocarbon from the mixture. The separator also includes a second separation unit of ultrafiltration through membranes, that receives the water coming from the gravimetric unit, that is to say without water free hydrocarbons. This unit separates the emulsified hydrocarbons from the mixture.

Besides these two basic separation units, the separator includes a control panel that controls the operation of all the elements and/or devices of the separator. It also includes a pump for the recirculation of the emulsified hydrocarbon-water mixture through the self-filtration unit as well as a pump to send the hydrocarbons separated in the gravimetric unit to the free hydrocarbons collecting tank.

Equally, the separator comprises a phase detector, which determines the quantity of hydrocarbon accumulated at the top part of the gravimetric unit. Therefore with the activation of the control panel—depending on the quantity of accumulated hydrocarbon—the suction pump of the hydrocarbon-water mixture, and subsequently the entry to this separation unit can be stopped. In this case, the hydrocarbon pump will start to operate, opening at the same time a valve at that allows the penetration of clean water to push the separated hydrocarbons to the collecting tank.

Also included are several valves, filters, and the like, including a flow meter, pressure and temperature transmitters, means for drainage, sluiceways and collecting facilities for separated products, as well as facilities that render possible the counter-flow cleaning of the ultrafiltration unit membranes. This cleaning is made with fresh water for the regeneration of the membranes themselves.

The separator works automatically and is regulated by a control panel that determinates the activation/stopping of the electro pumps. It also controls the opening/closing of the valves depending on the signals received by the hydrocarbon sensors or detectors and/or depending on the signals received by a hydrocarbon analyser also belonging to the separator.

The separator is valid either for the applications including the discharge of purified water through the gravimetric unit with a hydrocarbon content below the values established by the present regulations, and for the applications including the reuse of the separated hydrocarbons.

### DESCRIPTION OF THE DRAWINGS

As a complement to the following description, and with the aim of obtaining a better comprehension of the features of this invention, a drawing is enclosed which schematically represents the installation of the circuit corresponding to the emulsions separator made according the invention.

### DESCRIPTION OF THE PREFERRED EMBODIMENT OF THE INVENTION

Looking at the aforementioned FIGURE, it can be observed that the emulsions separator is based on the combination of two different separation technologies: gravimetric and ultrafiltration.

The gravimetric separation unit (1) located in reception tank (2) for the hydrocarbon-water mixture, through suction pipe (3), includes a FACET MPACK COALESCENT PLATES PACK, which makes up the gravimetric separation unit (1), being the hydrocarbon-water mixture sucked up by a suction pump (4).

The ultrafiltration separation unit (5) includes membranes (6), so that this separation unit (5) accesses the water mixture driven by an impeller pump (7), and this water is free from hydrocarbons since these hydrocarbons have been previously separated in the gravimetric separation unit (1).

The separator also includes a control panel (8) which controls the operation of all the components and devices described, as well as a hydrocarbon flow meter (9) located on the exit duct (10) of hydrocarbon free, clean, water.

The free hydrocarbons obtained in the gravimetric separation unit (1) and the emulsified hydrocarbons obtained in the separation unit (5) enter a common discharge pipe (11), that belongs to the same separator itself.

According to these main components and others that will be mentioned in the present description, the separator operation is as follows:

The mixture of hydrocarbon water to be treated is sucked by suction pump (4) introduced in the reception tank (2) bearing the gravimetric separation unit (1), through the suction pipe (3). This mixture of water with hydrocarbons passes through the FACET MPACK COALESCENT PLATES making up this gravimetric separation unit (1). Therefore, due to the existing laminar flow in these Coalescent Plates where the separation of the free hydrocarbon from the water takes place, and said free hydrocarbon is accumulated due to its lower weight, on the top part (12) where a phase detector (13) has been provided to evaluate the quantity of accumulated hydrocarbons in this top part (12).

When the quantity of free hydrocarbons exceeds the maximum established value, the phase detector (13), sends a signal to the control panel (8) carrying out the following operation:
Suction pump (4) stops, therefore detaining the entry of hydrocarbon-water mixture to the reception tank (2).
a hydrocarbon pump (14), from now on called ‘hydrocarbon pump’, stars to work and discharges the free hydrocarbons separated via the gravimetric separation unit (1) to the common discharge pipe (11) that is directly connected with the hydrocarbon collector or tank, or—a fresh water inlet automatic valve opens, allowing drinking water to push the hydrocarbon through its discharge connection to the hydrocarbon accumulation collector tank provided at the end of the common discharge pipe (11).

Once the hydrocarbon is out of the gravimetric separation unit, the phase detector (13) detects the presence of water, by sending a signal to the control panel (8). Said signal stops the hydrocarbon pump (14) or closes the fresh water inlet automatic valve. At the same time the suction pump restarts (4), leaving the separator in its standard operative situation.

This way, the water without free hydrocarbon passed through the impeller pump (7) and afterwards through the suction pump (4) towards the ultrafiltration separation unit (5), with the particular feature that between both pumps (4, 7) there is a solid particles retention filter (15). On said filter a branch (16) begins where an automatic valve (17) for discharging purposes is intercalated. A second branch (18) connected to the retention filter (15) exists, for the cleaning of said filter through counter flow, through a valve (24) provided in the second branch (18) itself. Said second branch (18) is connected to the drinking water inlet line (25), being in this inlet a filter (26) and also an automatic valve (27).

In the outlet of the retention filter (15), and particularly in the line or branch, between the pumps (4, 7) a branch (28) has been provided with a pressure control valve (29) that opens automatically as soon as the pressure increases up to the maximum value allowed, alleviating the suction of the suction pump (4).

The mixture of water without free hydrocarbon, coming from the reception tank (2) of the gravimetric separation unit is powered by an impeller pump (7) through the membranes belonging to the ultrafiltration separation unit (5), so that in this unit all the particles of hydrocarbon higher than 5 nanometers are retained, being stored in the membranes (6). The water that passes through these membranes already clean of hydrocarbons, is conducted through a flow meter (30) and through an automatic valve (31) to the outlet collector provided at the end of the exit duct (10). For this reason, this exit duct (10) is considered as the outlet collector of hydrocarbon free water, providing a sample probe for continuous analysis of the discharged water, so when the quantity of hydrocarbon in water measured by the hydrocarbon flow meter (9) is lower or equal to the reference value, this hydrocarbon flow meter (9) sends a signal to the control panel (8), producing the opening of the discharge automatic valve (32), and at the same time the recirculation automatic valve (33) closes to the entry tank. However, if the quantity of hydrocarbon in water measured is superior to the reference value, this hydrocarbon flow meter (9) sends a signal to the control panel (8), closing the clean water discharge automatic valve (32) and opening the recirculation automatic valve (33) to the entry tank.

Every certain quantity of liters of discharged water, which have passed through the membranes (6) of the ultrafiltration separation unit (5) and have been measured by the hydrocarbon flow meter (9), or certain number of working hours of the ultrafiltration separation unit (5), or when the concentration of hydrocarbon requires it, in all the cases, the ultrafiltration separation unit (5) makes a discharge of the concentrate retained in the membranes (6).

For this purpose, the control panel (8) closes the automatic valve (31) and opens the automatic valve (34), allowing the discharge of said concentrate to the common discharge pipe (11) of the hydrocarbon storage collector, after having passed through the flow meter (35).

When necessary, cleaning through counter-flow of the ultrafiltration separation unit (5) is carried out, for which the drinking water inlet automatic valve (36) is opened, valves (31, 37, 34) are closed, the suction pump (4) is stopped and the automatic valve (38) is opened, allowing the discharge by gravity of the water from the counter-flow cleaning to the common pipe of the drainage collector (39) provided as a branch in the major conduction (40).

1. Physically and chemically emulsified hydrocarbon-water separator for ships' bilges, constructed to separate in an independent way the free hydrocarbon as well as the emulsified hydrocarbon out of a mixture of hydrocarbon-water comprising
two separation units, the first one as a gravimetric separation unit with Coalescent Plates to separate free hydrocarbon in the mixture of hydrocarbon-water, while the second separation unit is a membrane ultrafiltration separation unit to separate the emulsified hydrocarbon;
provided with a suction pump for the mixture of hydrocarbon-water at the entrance, through a pipe, in each tank situated in the gravimetric separation unit, including a propeller pump of water clean of free hydrocarbon, coming out from the gravimetric separation unit for its entry to, and passing through, the ultrafiltration separation unit,
having also a second propeller pump for the carriage of the discarded hydrocarbon from the gravimetric separation unit to a pipe or common collector that flows to a storage tank;
including a detector of accumulated free hydrocarbon in a top part of the coalescent plate gravimetric separation unit, as well as a control panel by means of which the functioning of the pumps, valves, and devices that allow the entry of clean water is automatically controlled according to the signals emitted by the detector of free hydrocarbon, by water detectors and by the detectors coming from a hydrocarbon analyser provided in the separator.

2. Physically and chemically emulsified hydrocarbon waters separator for ships' bilges, according to claim 1, comprising a filter of solid particle retention in a branch between the gravimetric separation unit and the ultrafiltration separation unit, between the pumps; said filter carrying the mixture of water without the free hydrocarbon, being a pressure control valve provided at the outlet of this filter to eventually relief the pump pressure; said filter being connected to a branch to clean by counter-flow through an automatic valve, and connected to a discharge branch through a second automatic valve.

3. Physically and chemically emulsified hydrocarbon-water separator for ships' bilges, according to claim 1, wherein the ultrafiltration separation unit has an exit duct for clean water obtained in the passage through the membranes of said ultrafiltration separation unit, in said exit duct there are a flow meter and an automatic valve; being said clean water sent through said valve to an outlet collector for its collection in a storage tank; in said outlet collector a continuous analysis of discharged water sampling off-take takes place; in said exit duct there is a first valve provided in combination with a second valve that closes when the first one opens and vice-versa, allowing in this last case the re-circulation of water to a tank receiver of the hydrocarbon-water mixture.

4. Physically and chemically emulsified hydrocarbon waters separator for ships' bilges, according to claim 3, wherein the exit duct of the ultrafiltration separation unit has a diversion with an automatic valve for the intake of drinking water for the cleaning by counter-flow of the membranes of said separator unit.

5. Physically and chemically emulsified hydrocarbon waters separator for ships' bilges, according to claim 1, wherein the separator unit has a branch with an automatic valve and a flow meter, said branch is connected with a common collector conduit, so that the separator unit reaches said branch through the common collector conduit.
